(19) United States
(12) Patent Application Publication
(10) Pub. No.: US 2008/0121249 A1
(43) Pub. Date: May 29, 2008

(54) Method for Cleaning Film-Forming Apparatuses

(76) Inventors: Julien Gatineau, Ibaraki (JP); Christian Dussarrat, Ibaraki (JP); Kazutaka Yanagita, Ibaraki (JP); Tomomi Fujita, Ibaraki (JP); Jean-Marc Girard, Paris (FR)

Correspondence Address: AIR LIQUIDE;Intellectual Property, 2700 POST OAK BOULEVARD, SUITE 1800, HOUSTON, TX, 77056, US

(21) Appl. No.: 10/583,641

(22) PCT Filed: Dec. 10, 2004
(86) PCT No.: PCT/IB04/04131

§ 371 Date: Mar. 27, 2007

(30) Foreign Application Priority Data
Dec. 25, 2003 (JP) 2003-430763

(51) Int. Cl. B08B 5/00

(52) U.S. Cl. 134/2

(57) ABSTRACT

To provide an efficient method for cleaning film-forming apparatuses in order to remove a ruthenium-type deposit residing on a constituent member of a film-forming apparatus after said apparatus has been used to form a film comprising ruthenium or solid ruthenium oxide, wherein at least the surface region of the ruthenium-type deposit comprises solid ruthenium oxide.

A ruthenium-type deposit, at least the surface region of which is solid ruthenium oxide, is brought into contact with reducing gas that contains a reducing species comprising hydrogen or hydrogen radical and the solid ruthenium oxide is thereby converted into ruthenium metal. This ruthenium metal is subsequently converted into volatile ruthenium oxide by bringing the ruthenium metal into contact with an oxidizing gas that contains an oxidizing species comprising an oxygenated compound, and this volatile ruthenium oxide is removed from the film-forming apparatus.

This invention relates to a method for cleaning film-forming apparatuses. More specifically, this invention relates to a method for cleaning a film-forming apparatus after the apparatus has been used to form a film comprising ruthenium or solid ruthenium oxide.

Ruthenium materials, such as ruthenium metal and solid ruthenium oxide such as ruthenium dioxide, are becoming increasingly important as component materials in semiconductor devices; they are used, for example, as electrode materials for semiconductor memories.

Films of ruthenium materials can be formed on semiconductor wafers by sputtering and chemical vapor deposition (CVD). During these film fabrication processes, ruthenium or ruthenium dioxide, as the case may be, is deposited not only on the semiconductor wafer target, but also on constituent members of the film-forming apparatus, for example, on the inner walls of the sputtering or CVD chamber (collectively referred to below as the film-forming chamber) and on the semiconductor wafer mounting boat or susceptor, within conduits, and so forth. When these ruthenium-type deposits are not removed, they exfoliate from, for example, the inner walls of the film-forming chamber and in this manner are a cause of particle generation, thereby leading to a deterioration in the quality of the semiconductor thin films subsequently formed on the semiconductor wafers. The film-forming apparatus must therefore undergo cleaning.

Patent Reference 1 describes the removal of ruthenium or solid ruthenium oxide (e.g., ruthenium dioxide) attached to the film-forming chamber by contact with aqueous ceric ammonium nitrate solution. However, wet methods such as this are inconvenient in terms of handling and also provide a low removal efficiency.

In contrast to this, Patent Reference 2 describes a dry method that removes ruthenium metal as ruthenium tetroxide, a volatile compound. This is done by bringing the ruthenium metal deposited on the inner walls of the film-forming chamber into contact with an atomic oxygen-donating gas, such as ozone.

### Patent Reference 1

U.S. Pat. No. 6.143,192

### Patent Reference 2

### Japanese Laid Open (Unexamined or Kokai or A) Patent Application Number Hei 10-30439-(30,439/1998)

The inventors carried out intensive research into the use of oxidizing gas (e.g., ozone) to remove ruthenium deposited on the inner walls of the film-forming chamber. As a result, it was discovered that, due to oxygen adsorbed to the film-forming chamber and oxygen from, for example, silicon oxide film formed on the semiconductor wafer, solid ruthenium oxide, such as ruthenium dioxide, is formed on the surface of ruthenium metal that has become deposited on the inner walls of a film-forming chamber that has been used to form a ruthenium metal film. It was also found that this solid ruthenium oxide at the surface prevents removal of the ruthenium metal by ozone. This also means that ozone is not highly effective for the removal of solid ruthenium oxide, such as ruthenium dioxide.

The object of this invention, therefore, is to provide an efficient method for cleaning film-forming apparatuses in order to remove a ruthenium-type deposit residing on a constituent member of a film-forming apparatus after said apparatus has been used to form a film comprising ruthenium or solid ruthenium oxide, wherein at least the surface region of the ruthenium-type deposit comprises solid ruthenium oxide.

The present inventors discovered that a particular film-forming apparatus can be very efficiently cleaned by
bringing the solid ruthenium oxide formed on the ruthenium metal into contact with a reducing gas that contains hydrogen or the hydrogen radical (reducing species), thereby reducing the solid ruthenium oxide to ruthenium metal, and
subsequently bringing the ruthenium metal into contact with an oxidizing gas that contains an oxygenated compound (oxidizing species), e.g., ozone, and exhausting it from the system as a volatile ruthenium compound.

This reduction by reducing gas containing hydrogen or the hydrogen radical can of course also be applied to ruthenium-type deposits comprising solid ruthenium oxide. The ruthenium metal produced by this reduction can, as above, be brought into contact with oxidizing gas and removed from the system as a volatile ruthenium compound.

Thus, this invention provides a method for cleaning a film-forming apparatus in order to remove a ruthenium-type deposit residing on a constituent member of the film-forming apparatus after said apparatus has been used to form a film comprising ruthenium or solid ruthenium oxide, wherein at least the surface region of the ruthenium-type deposit comprises solid ruthenium oxide, said method being characterized by
converting the aforesaid solid ruthenium oxide into ruthenium metal by bringing the ruthenium-type deposit into contact with a reducing gas that contains a reducing species comprising hydrogen or the hydrogen radical,
subsequently converting the ruthenium metal into volatile ruthenium oxide by bringing the ruthenium metal into contact with an oxidizing gas that contains an oxidizing species comprising an oxygenated compound, and
removing this volatile ruthenium oxide from the film-forming apparatus.

This invention can efficiently clean a film-forming apparatus in order to remove a ruthenium-type deposit residing on a constituent member of the film-forming apparatus after said apparatus has been used to form a film comprising ruthenium or solid ruthenium oxide, wherein at least the surface region of the ruthenium-type deposit comprises solid ruthenium oxide.

This invention is described more specifically hereinbelow.

This invention relates to a method for cleaning a film-forming apparatus in order to remove a ruthenium-type deposit residing on a constituent member of the film-forming apparatus after said apparatus has been used to form a film comprising ruthenium or solid ruthenium oxide, wherein at least the surface region of the ruthenium-type deposit comprises solid ruthenium oxide.

The film-forming apparatus encompasses, for example, a film-forming chamber, the lines (conduits) that introduce and exhaust the CVD precursor gas and carrier gas, and so forth. In addition, there is disposed within the film-forming apparatus a mounting member that carries or supports the semiconductor wafer that is the target of the intended film-formation process. This mounting member may be, for example, a boat in the case of a batch-type film-forming apparatus or a susceptor in the case of a single- wafer film-forming apparatus. The constituent members of the film-forming apparatus include the aforesaid film-forming chamber, conduits connected to the film-forming chamber, the semiconductor wafer mounting member, and so forth.

According to the present invention, the ruthenium-type deposit residing on a constituent member of the film-forming apparatus is first brought into contact with a reducing gas that contains hydrogen or the hydrogen radical (reducing species), thereby converting (reducing) the solid ruthenium oxide, e.g., ruthenium dioxide, to ruthenium metal. This reduction can be effected by passing the reducing gas within the film- forming apparatus.

This reducing gas can be composed of only hydrogen, but the hydrogen is preferably adequately diluted with an inert gas based on safety considerations. The reducing gas is preferably composed of inert gas that contains 1-5 volume % hydrogen. Nitrogen is particularly preferred for the inert gas.

The reduction is preferably carried out at 80° C.-800° C. and more preferably at 120° C.-250° C. The pressure within the film-forming apparatus during reduction is preferably established at 0.01-1000 torr. The reduction can be completed in 0.5 to 50 minutes. This reduction converts the solid ruthenium oxide to ruthenium metal with the production of H₂O. Introduction of the reducing gas is halted when the reduction is finished.

The ruthenium metal afforded by the reduction is then brought into contact with oxidizing gas containing an oxygenated compound (oxidizing species). Prior to this, however, it is preferable based on safety considerations that the interior of the film-forming apparatus be purged post-reduction by the passage of an inert gas (preferably nitrogen) in order to thoroughly discharge from the film-forming apparatus any residual hydrogen or hydrogen radical that may be present.

The oxidizing gas containing an oxygenated compound (oxidizing species) is passed through the film-forming apparatus after the hydrogen and hydrogen radical have been exhausted, i.e., substantially in the absence of hydrogen and hydrogen radical. This passage of the oxidizing gas converts (oxidizes) the ruthenium metal into volatile ruthenium oxide (ruthenium tetroxide, etc.).

The oxygenated compound includes ozone (O₃), oxygen (O₂), nitric oxide (NO), nitrogen dioxide (NO₂), nitrous oxide (N₂O), water vapor (H₂O), hydrogen peroxide (H₂O₂), and their mixtures wherein oxygen and ozone are preferred. The oxidizing gas preferably contains at least 2 volume % ozone and preferably 2-5 volume % ozone. The oxidizing gas can be oxygen gas containing about 5% ozone as produced by a commercial ozone generator.

This oxidation can be run preferably at 0° C.-150° C. and is more preferably run at room temperature (20° C.-30° C.) without heating. This oxidation serves to convert the ruthenium metal to volatile ruthenium oxide (ruthenium tetroxide).

The completion of this oxidation can be detected by monitoring production of the volatile ruthenium oxide. For example, the gas exhaust line from the film-forming apparatus can be provided with a concentration detection unit that detects the concentration of the volatile ruthenium oxide in the exhaust gas stream from the film-forming apparatus. This concentration detection unit can comprise an ultraviolet spectrometer, Fourier-transform infrared spectrometer, Raman spectrometer, or other known detection unit capable of measuring the concentration of the volatile ruthenium oxide. The point of oxidation completion is the point at which volatile ruthenium oxide is no longer detected by the concentration detection unit in the exhaust gas stream from the film-forming apparatus. The introduction of oxidizing gas can be stopped at this point. This concentration detection enables the start and completion of ruthenium metal oxidation to be promptly comprehended. When during this cleaning by oxidation of the ruthenium metal cleaning does not advance due to the formation of a thin layer of oxide on the surface of the ruthenium metal, the introduction of the oxidizing gas can be halted, the interior of the film-forming apparatus can be thoroughly exhausted and purged with an inert gas such as nitrogen, and the above-described reduction and oxidation can be repeated.

The volatile ruthenium oxide-containing exhaust gas stream from the film-forming apparatus is discharged from the system after, inter alia, the volatile ruthenium oxide has been removed by the usual means. However, it has been found that the volatile ruthenium oxide can be efficiently removed from the exhaust gas stream from the film-forming apparatus by heating this exhaust gas from the film-forming apparatus (the first removal method) or by bringing the exhaust gas into contact with a decomposition catalyst comprising ruthenium metal or a solid ruthenium compound (the second removal method) that has been set up in advance.

The volatile ruthenium oxide is decomposed and removed in the first removal method by heating the exhaust gas stream from the film-forming apparatus. This thermal decomposition converts the volatile ruthenium oxide into solid ruthenium oxide, which undergoes deposition. Heating the exhaust gas stream from the film-forming apparatus to 50° C.-800° C. enables a much more effective decomposition and detoxification of the volatile ruthenium oxide. The exhaust gas stream from the film-forming apparatus is also preferably heated under a pressure of 0.01-1000 torr. The use of a heating temperature ≧100° C. also enables decomposition of ozone that may be present in the exhaust gas stream from the film-forming apparatus.

This thermal decomposition of the volatile ruthenium oxide can be carried out using a decomposition unit whose interior defines at least one flow path for the exhaust gas stream from the film-forming apparatus. A heater for thermal decomposition is elaborated over the circumference of this decomposition unit. This decomposition unit should have a structure that causes little pressure loss at the gas stream inlet and outlet, but the decomposition unit is not otherwise particularly specified. The decomposition unit can be constituted, for example, of a tubular body. This tubular body may define a single gas flow path in its interior or may define a plurality of gas flow paths in its interior, for example, as in a honeycomb structure. A decomposition unit whose interior defines a plurality of gas flow paths is preferred from the standpoint of decomposition efficiency. The decomposition unit can be made of heat-resistant material that is not corroded by the volatile ruthenium oxide (for example, quartz, stainless steel). The exhaust gas stream from the film-forming apparatus is introduced into the decomposition unit through an open end (gas inlet) thereof and flows within the gas flow path(s) while being heated by the heater at the temperature cited above. The volatile ruthenium oxide decomposed within the decomposition unit is converted to solid ruthenium oxide that deposits on the inner walls of the decomposition unit. A gas stream from which the volatile ruthenium oxide has been removed is discharged from the other open end (outlet) of the decomposition unit. As discussed below, solid ruthenium oxide attached on the inner walls of the decomposition unit itself functions as a decomposition catalyst for the volatile ruthenium oxide. As a consequence, once solid ruthenium oxide produced by the heating-induced decomposition of the volatile ruthenium oxide has become deposited on the inner walls of the decomposition unit, the volatile ruthenium oxide can still be thoroughly decomposed even when the heating temperature is dropped.

In the second removal method, the exhaust gas stream from the film-forming apparatus is brought into contact with a particular decomposition catalyst that has been laid out in advance. The use of a decomposition catalyst enables a much more effective removal of the volatile ruthenium oxide than simple heating alone. Ruthenium metal or a solid ruthenium compound is used as this decomposition catalyst. The solid ruthenium compound can be exemplified by ruthenium dioxide and ruthenium trifluoride. Viewed from the perspective of the convenient recovery described below, this solid ruthenium compound is preferably the solid ruthenium oxide that is the decomposition product of the volatile ruthenium oxide.

When the exhaust gas stream from the film-forming apparatus is brought into contact with these decomposition catalysts, the volatile ruthenium oxide in the exhaust gas stream is converted to a solid ruthenium oxide that deposits on the decomposition catalyst. This contact between the decomposition catalyst and exhaust gas stream from the film-forming apparatus can be carried out at pressures of 0.01-1000 torr.

The exhaust gas stream from the film-forming apparatus can be brought into contact with the decomposition catalyst at 0° C.-800° C., but the volatile ruthenium oxide can be thoroughly removed even at ≦300° C.

Contact between the exhaust gas stream from the film-forming apparatus and the decomposition catalyst is most preferably carried out by attaching the decomposition catalyst on the walls of the gas flow path(s) of a decomposition unit as described above in relation to the first removal method and then passing the exhaust gas stream through said gas flow path(s).

The concentration of the volatile ruthenium oxide in the effluent gas stream from the decomposition unit can be monitored in order to set the initial conditions for decomposition of the volatile ruthenium oxide and in order to control the decomposition efficiency. This concentration monitoring can be conducted using the same unit for detecting volatile ruthenium oxide as described above.

This invention is described in additional detail hereinbelow with reference to the drawings. The same reference symbols have been assigned to the same elements throughout all the drawings.

FIG. 1 contains a block drawing that illustrates an example of a film-forming apparatus that is provided with a system that successively implements cleaning of the film-forming apparatus and removal of volatile ruthenium oxide in accordance with the present invention.

The film-forming apparatus 10 is provided with a film-forming chamber 101. Disposed within the film-forming chamber 101 is a wafer mounting platform 102 on which the semiconductor wafer (not shown) is mounted. A wafer heating unit (not shown) can be disposed within this wafer mounting platform 102. A heating unit 103 is disposed on the circumference of the film-forming chamber 101 in order to heat the interior of the film-forming chamber 101 to a prescribed temperature. Components such as, for example, a conduit system, control valves, flow rate adjustment devices, and other necessary elements for introduction of the carrier gas and film-generating precursor gas are of course disposed at and around the film-forming apparatus 10, but with the exception of the pump these are not shown for the sake of simplicity.

The system for cleaning the film-forming apparatus 10 includes a hydrogen cylinder 201 (reducing gas source) and an ozone generator 202 (oxidizing gas source). Hydrogen gas from the hydrogen cylinder 201 is introduced through the line L101 into the film-forming chamber 101, while ozone-containing oxygen gas is introduced from the ozone generator 202 through the line L102 into the film-forming chamber 101. A switching valve V1 is disposed at the confluence of the line L101 and the line L102. An oxygen cylinder 203 is connected through the line L103 to the ozone generator 202.

The system 30 for removing volatile ruthenium oxide is provided with a decomposition unit proper 301 whose interior defines at least one flow path 301a for the exhaust gas stream that is discharged from the film-forming apparatus and that contains the volatile ruthenium oxide (gas) produced by cleaning. This decomposition unit proper 301 has a gas inlet 301b and a gas outlet 301c. The gas inlet 301b is connected through the line L301 to the gas exhaust port of the film-forming chamber 101. A heating unit (heater) 302 is disposed on the circumference of the decomposition unit proper 301 in order to heat the exhaust gas stream flowing from the film-forming apparatus into the gas flow path 301a.

A pump 40 that transports the gas stream through the interior of the decomposition unit proper 301 is connected through the line L302 downstream from the decomposition unit proper 301. A pump as generally used in film-forming apparatuses can be directly used for this pump 40. In other words, the decomposition unit proper can be placed between the film-forming chamber and pump in the usual pump-equipped gas exhaust system of a film-forming apparatus. An exhaust gas treatment facility 50 is disposed downstream from the pump 40 through the line L303; this exhaust gas treatment facility 50 treats the exhaust gas stream outflowing from the decomposition unit proper 301.

The decomposition unit proper 301 can be constituted of, for example, a tube 311, as schematically illustrated in cross section in FIG. 2. This tube 311 typically has a cylindrical shape for the corresponding ease of use, but the tube 311 is not limited to this shape. The decomposition unit proper 301 may also be constituted of a honeycomb structure, again as described above. The tube 311 is composed of a heat-resistant material that is not corroded by the volatile ruthenium oxide (for example, quartz or stainless steel).

The exhaust gas treatment facility 50 removes gaseous species—other than the volatile ruthenium oxide—that can be present in the gas stream outflowing from the decomposition unit proper 301 after completion of the decomposition treatment thereon. The exhaust gas treatment facility 50 can be a wet- or dry-process exhaust gas facility as known per se or a plasma facility as known per se. For example, active alumina is effective for the decomposition of ozone.

The interior of the film-forming apparatus 10 is thoroughly exhausted by the operation of the pump 40 once it becomes necessary to clean the film-forming apparatus 10 after execution of ruthenium film formation or ruthenium dioxide film formation, i.e., when it becomes necessary to remove a ruthenium-type deposit—at least the surface region of which comprises solid ruthenium oxide—residing on a constituent member of the film-forming apparatus. This is followed by the introduction into the film-forming chamber 101 of hydrogen gas from the hydrogen cylinder 201, preferably along with inert gas as described above, and reduction of the solid ruthenium oxide in the ruthenium-type deposit to ruthenium metal.

The hydrogen gas is stopped post-reduction using the switching valve V1 and the interior of the film-forming chamber 101 is thoroughly exhausted and purged with an inert gas such as nitrogen in order to remove hydrogen and hydrogen radical from the film-forming apparatus 10.

Ozone-containing oxygen gas is then introduced from the ozone generator 202 into the film-forming chamber 101 by switching at the switching valve V1. The ruthenium metal is brought into contact with the ozone-containing oxygen gas and is oxidized and converted into volatile ruthenium oxide, which is discharged from the film-forming chamber 101.

The decomposition unit proper 301 is heated to a prescribed temperature by the heater 302 and the volatile ruthenium oxide-containing exhaust gas stream from the film-forming chamber is introduced at a prescribed pressure into the decomposition unit proper 301. The volatile ruthenium oxide in the heated exhaust gas stream from the film-forming chamber is decomposed and converted into solid ruthenium oxide, which deposits on the inner walls of the decomposition unit proper 301. The ozone that can be present in the exhaust gas stream from the film-forming chamber undergoes decomposition when the heating temperature under consideration is at least 100° C.

A concentration detection unit 204, whose purpose is to detect the concentration of volatile ruthenium oxide in the exhaust gas stream from the film-forming chamber 101, is preferably also disposed between the film-forming chamber 101 and the decomposition unit proper 301. This concentration detection unit 204 can comprise an ultraviolet spectrometer, Fourier-transform infrared spectrometer, Raman spectrometer, or other known detection unit capable of measuring the concentration of the volatile ruthenium oxide. This concentration detection unit 204 enables the oxidizing gas to be stopped at the point at which volatile ruthenium oxide is no longer detected in the exhaust gas stream from the film-forming chamber 101, which enables the decomposition process to be carried out in an efficient manner.

A concentration detection unit 303 for detection of the volatile ruthenium oxide concentration is provided between the decomposition unit proper 301 and the pump 40. As already noted above, this can be utilized to set the initial conditions for decomposition of the volatile ruthenium oxide and to support control of the decomposition efficiency.

FIG. 3 contains a schematic cross-sectional drawing that illustrates an example of a decomposition unit proper 301 that contains decomposition catalyst. A decomposition catalyst 312 comprising ruthenium metal or solid ruthenium oxide is attached to the inner wall of the tube 311 constituting the decomposition unit proper 301.

The procedure using a decomposition unit proper 301 provided with a decomposition catalyst 312 is substantially the same as the procedure already described above. The volatile ruthenium oxide in the gas stream brought into contact with the decomposition catalyst 312 undergoes decomposition and is converted into solid ruthenium oxide, which deposits on the decomposition catalyst 312.

Since volatile ruthenium oxide is toxic, the interior of the decomposition unit proper 301 is preferably maintained under reduced pressure based on safety considerations. The pressure within the decomposition unit proper 301 need not be specifically controlled and can be the same as the pressure in the film-forming chamber 101.

FIG. 4 contains a block drawing that illustrates another example of a film-forming apparatus that is provided with a system that successively implements cleaning of the film-forming apparatus and removal of the volatile ruthenium oxide in accordance with the present invention. Those elements in FIG. 4 that are the same as in FIG. 1 have been assigned the same reference symbols as in FIG. 1 and will not be described in detail again.

The apparatus shown in FIG. 4 has approximately the same structure as the apparatus shown in FIG. 1, with the exception that the decomposition unit proper 301 is disposed in a line L401 that branches from the line L301 rather than being connected in the line L301 that connects to the film-forming chamber 101 and pump 40 as shown in FIG. 1. The gas stream from the decomposition unit proper 301 connected in the branch line L401 flows into the line L301 through the line L402, i.e., the line L402 joins with the line L301 upstream from the pump 40. The line L301 has a shut-off valve V21 upstream from the point of confluence with the line L402, while a shut-off valve V22 is provided in the line L401 and a shut-off valve V23 is provided in the line L402. A concentration detection unit 204 is provided in the apparatus illustrated in FIG. 4 on the line L301 upstream from the branch point with the line L401.

The interior of the film-forming apparatus 10 is thoroughly exhausted by the operation of the pump 40 once it becomes necessary to clean the film-forming apparatus 10 after execution of ruthenium film formation or ruthenium dioxide film formation, i.e., when it becomes necessary to remove a ruthenium-type deposit—at least the surface region of which comprises solid ruthenium oxide—residing on a constituent member of the film-forming apparatus. The shut-off valves V22 and V23 are closed during this phase. The shut-off valves V22 and V23 are of course also closed during the film formation phase.

Once the interior of the film-forming apparatus 10 has been thoroughly exhausted, reducing gas is introduced into the film-forming chamber 101 as described in relation to FIG. 1 and the desired reduction is carried out. As described in relation to FIG. 1, the hydrogen gas is stopped post-reduction using the switching valve V1 and the interior of the film-forming chamber 101 is thoroughly exhausted and purged with an inert gas such as nitrogen in order to remove hydrogen and hydrogen radical from the film-forming apparatus 10. The shut-off valve V21 is then closed and the shut-off valves V22 and V23 are opened and ozone-containing oxygen gas is introduced into the film-forming chamber 101 again as described in relation to FIG. 1. The ruthenium metal is brought into contact with the ozone-containing oxygen gas and is oxidized and converted into volatile ruthenium oxide, which is discharged from the film-forming chamber 101. Decomposition of the volatile ruthenium oxide in the exhaust gas stream from the film-forming chamber is also carried out as already described above. Cleaning is complete when volatile ruthenium oxide is no longer detected by the concentration detection unit 204. Once cleaning has been completed, the flow of oxygen gas is stopped and the shut-off valves V22 and V23 are closed and preparation is made for the ensuing film fabrication process.

The concentration detection unit 204 is disposed in FIG. 4 in the line L301 upstream from the branch point with the line L401, but this concentration detection unit 204 can be placed between the switching valve V22 and the decomposition unit proper 301 when the exhaust gas stream from the film-forming chamber contains gas that would interfere with detection of the volatile ruthenium oxide concentration by the concentration detection unit 204.

According to the inventive method for removing volatile ruthenium oxide, the volatile ruthenium oxide in a gas stream is decomposed into solid ruthenium oxide, which deposits within the decomposition unit. As a consequence, the solid ruthenium oxide can be easily recovered by removing the decomposition unit after the decomposition process, both in the case of a decomposition unit not provided with decomposition catalyst and in the case of a decomposition unit containing a ruthenium metal or solid ruthenium oxide decomposition catalyst. This recovery has heretofore been problematic.

### EXAMPLES

Examples of this invention are described below, but this invention is not limited by these examples.

### Example 1

Chromium was deposited in a thickness of 500 Å as a bonding layer on the surface of a silicon substrate and ruthenium metal was then vapor-deposited thereon under reduced pressure to a thickness of 1000 Å. The formation of ruthenium dioxide in a thickness of 10-50 Å on the surface of the ruthenium metal was measured by Auger electron spectroscopy (AES).

This silicon substrate was installed in a cylindrical quartz tube (length=60 cm, inner diameter=1.5 cm) and hydrogen and nitrogen (carrier gas) were then passed through the quartz tube at 200° C./700 torr for 5 minutes. The hydrogen flow rate was 4 sccm and the nitrogen flow rate was 100 sccm. It was confirmed by AES that the result of this treatment was the reduction of all the ruthenium dioxide in the surface region to ruthenium metal.

After the interior of the quartz tube had then been purged with nitrogen, ozone-containing oxygen gas (ozone content=4.7 volume %) from a commercial ozone generator was passed at a flow rate of 150 sccm through the quartz tube at room temperature/700 torr. During this process, the absorbance (wavelength=376 nm) by ruthenium tetroxide in the effluent gas from the quartz tube was measured with a UV spectrophotometer. The results are reported in FIG. 5. According to the results in FIG. 5, almost no ruthenium oxide was observed at 120 seconds after the introduction of the ozone-containing gas and the ruthenium oxide had completely disappeared after 150 seconds.

### Example 2

Hydrogen and nitrogen (carrier gas) were passed for 10 minutes at 200° C./700 torr through a cylindrical quartz tube (length=60 cm, inner diameter=1.5 cm) whose inner wall carried ruthenium dioxide in a thickness of at least 10000 Å. The hydrogen flow rate was 4 sccm and the nitrogen flow rate was 100 sccm. It was confirmed by AES that the result of this treatment was the reduction of all the ruthenium dioxide to ruthenium metal.

After the interior of the quartz tube had then been purged with nitrogen, ozone-containing oxygen gas (ozone content=4.7 volume %) from a commercial ozone generator was passed at a flow rate of 150 sccm through the quartz tube at room temperature/700 torr. During this process, the absorbance (wavelength=376 nm) by ruthenium tetroxide in the effluent gas from the quartz tube was measured with a UV spectrometer. The results are reported in FIG. 6. According to the results in FIG. 6, ruthenium oxide was completely absent at 300 seconds (5 minutes) after the introduction of the ozone-containing oxygen gas.

### Reference Example 1

(A) A decomposition unit (not provided with decomposition catalyst) comprising a cylindrical quartz tube with a length of 60 cm and an inner diameter of 1.5 cm was used in this procedure. Nitrogen carrier gas containing a constant proportion of ruthenium tetroxide was introduced into the cylindrical tube at a flow rate of 10 sccm at different temperatures and pressures (5-20 torr) in the cylindrical tube. The ruthenium tetroxide concentration in the gas stream flowing out of the decomposition unit was measured with an ultraviolet spectrometer. Curve a in FIG. 7 reports the relationship between the ruthenium tetroxide concentration in the outflowing gas stream and the heating temperature wherein the ruthenium tetroxide concentration in the initial gas stream is designated as 100. About the same results as reported by curve a were obtained regardless of the pressure in the decomposition unit (5-20 torr).

As shown by the curve a results in FIG. 7, ruthenium tetroxide was almost completely removed in this reference example at temperatures ≧ about 215° C.

(B) A pressure of 700 torr was then established in the same decomposition unit and oxygen containing 4.7 volume % ozone was introduced at a flow rate of 150 sccm into the decomposition unit at different temperatures in the decomposition unit. The ozone concentration in the gas stream flowing out of the decomposition unit was measured with an ultraviolet spectrometer. The results showed that the ozone was about 99% decomposed at a heating temperature of 100° C. and was 100% decomposed at a heating temperature of 140° C. This confirmed that ozone and ruthenium tetroxide could be simultaneously removed by the thermal decomposition unit.

### Reference Example 2

The same procedure as in Reference Example 1(A) was carried out with the exception that a decomposition unit as described in Example 2 was used (cylindrical quartz tube whose inner wall carried ruthenium dioxide in a thickness of at least 10000 A). The results are reported by curve b in FIG. 7. About the same results as reported by curve b were obtained regardless of the pressure in the decomposition unit (5-20 torr).

As shown by the curve b results in FIG. 7, ruthenium tetroxide was almost completely removed by decomposition in this reference example at temperatures ≧ about 150° C.

### BRIEF DESCRIPTION OF THE DRAWINGS

FIG. 1 contains a block drawing that illustrates an example of the structure of a film-forming apparatus that is provided with a system for carrying out the cleaning method according to the present invention.

FIG. 2 contains a schematic cross-sectional drawing that illustrates an example of a decomposition unit that can be used for the removal according to the present invention of volatile ruthenium oxide.

FIG. 3 contains a drawing that illustrates, in a partial cross-sectional side view, another example of a decomposition unit that can be used for the removal according to the present invention of volatile ruthenium oxide.

FIG. 4 contains a block drawing that illustrates another example of the structure of a film-forming apparatus that is provided with a system for carrying out the cleaning method according to the present invention.

FIG. 5 contains a graph that shows the relationship obtained in Example 1 between the treatment time and the absorbance indicative of the concentration of volatile ruthenium oxide in the gas outflowing from a film-forming chamber.

FIG. 6 contains a graph that shows the relationship obtained in Example 2 between the treatment time and the absorbance indicative of the concentration of volatile ruthenium oxide in the gas outflowing from a film-forming chamber.

FIG. 7 contains a graph that shows the relationship between temperature and the concentration of volatile ruthenium oxide in the gas outflowing from a decomposition unit.

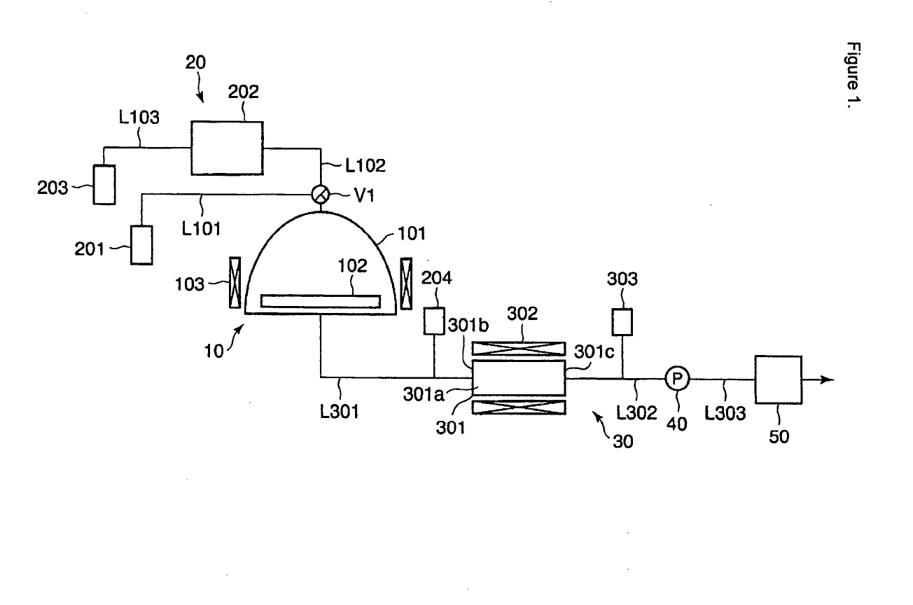

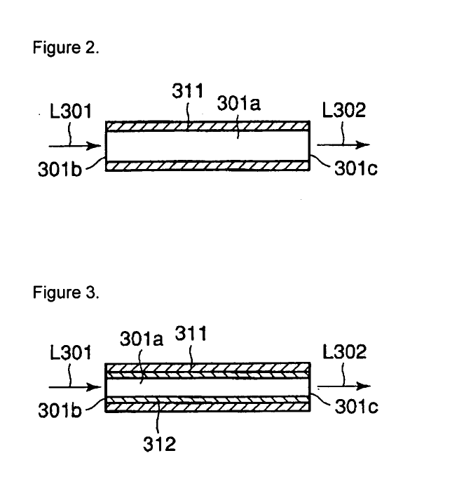

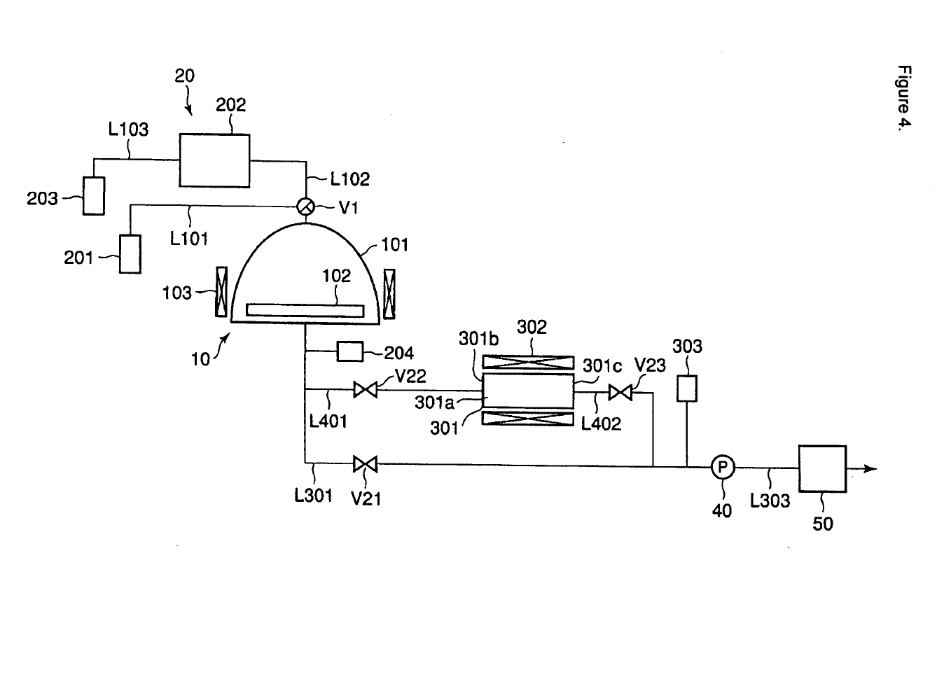

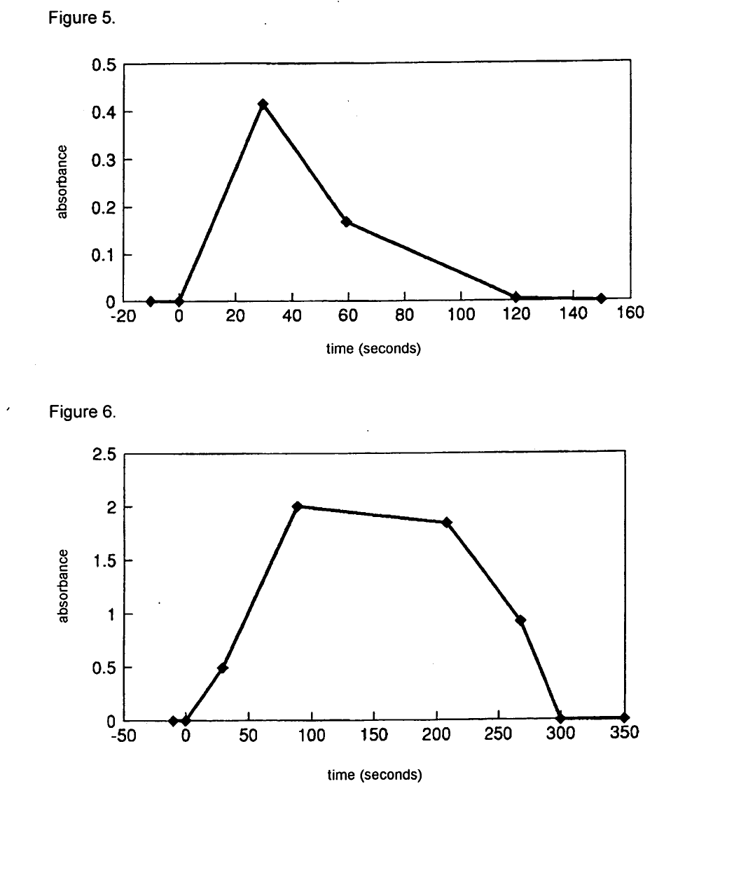

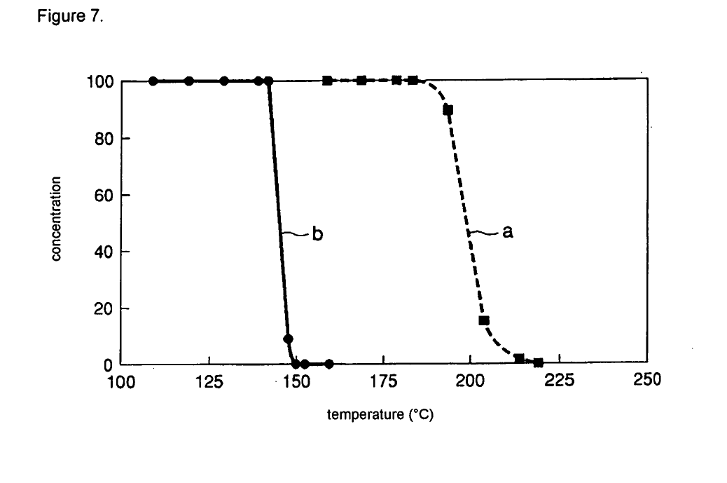

1-10. (canceled)

11. A method for cleaning a film-forming apparatus in order to remove a ruthenium-type deposit residing on a constituent member of the film-forming apparatus after said apparatus has been used to form a film comprising ruthenium or solid ruthenium oxide, wherein at least the surface region of the ruthenium-type deposit comprises solid ruthenium oxide, said method being characterized by:
a) converting the aforesaid solid ruthenium oxide into ruthenium metal by bringing the ruthenium-type deposit into contact with a reducing gas that contains a reducing species comprising hydrogen or the hydrogen radical;
b) subsequently converting the ruthenium metal into volatile ruthenium oxide by bringing the ruthenium metal into contact with an oxidizing gas that contains an oxidizing species comprising an oxygenated compound; and
c) removing this volatile ruthenium oxide from the film-forming apparatus.

12. The method of claim 11, wherein the reducing gas is composed of inert gas that contains hydrogen at from 1 to 5 volume %.

13. The method of claim 11, wherein contact between the ruthenium-type deposit and the reducing gas is carried out at 80° C. to 800° C.

14. The method of claim 11, wherein contact between the ruthenium-type deposit and the reducing gas is carried out at pressures of 0.01-1000 torr.

15. The method of claim 11, wherein the aforesaid oxidizing gas comprises ozone-containing oxygen gas originating from an ozone generator.

16. The method of claim 11, wherein contact between the ruthenium metal and oxidizing gas is carried out at 0° C. to 150° C.

17. The method of claim 11, wherein contact between the ruthenium-type deposit and oxidizing gas is carried out after the reducing species has been exhausted off.

18. The method of claim 11, characterized by:
a) monitoring the concentration of volatile ruthenium oxide in the volatile ruthenium oxide-containing gas stream flowing out of the film-forming apparatus; and
b) stopping the oxidizing gas at the point at which the volatile ruthenium oxide can no longer be detected in the aforesaid gas stream.

19. The method of claim 11, wherein the volatile ruthenium oxide-containing gas stream flowing out of the film-forming apparatus is heated in order to decompose the volatile ruthenium oxide therein.

20. The method of claim 11, wherein the volatile ruthenium oxide-containing gas stream flowing out of the film-forming apparatus is brought into contact with a decomposition catalyst comprising ruthenium metal or a solid ruthenium compound in order to decompose the volatile ruthenium oxide in said gas stream. IN THE UNITED STATES PATENT AND TRADEMARK OFFICE Application No.: Not yet assigned Applicants: Julien GATINEAU, et al. Filed Internationally: December 10, 2004 US National: Herewith Title: METHOD FOR CLEANING FILM-FORMING APPARATUSES TC/A.U: Unknown Examiner: Unknown Docket No.: Serie 6397 Customer No.: 000040582 PRELIMINARY AMENDMENT Commissioner for Patents P.O. Box 1450 Alexandria, VA 22313-1450 Dear Sir:
Prior to an examination of the merits of the above-identified U.S. patent application under 37 C.F.R. § 1.115, please first amend the application as follows:
Amendments to the Claims begin on page 2 of this paper.
Amendments to the Abstract begin on page 4 of this paper.
Remarks begin on page 5 of this paper.
An Appendix including the Abstract is attached following page 5 of this paper. Preliminary Amendment S6397 Amendments to the Abstract Please replace the subtitle and of the Abstract as follows:
Abstract of the Disclosure To provide an efficient method for cleaning film-forming apparatuses in order to remove a ruthenium-type deposit residing on a constituent member of a film-forming apparatus after said apparatus has been used to form a film comprising ruthenium or solid ruthenium oxide, wherein at least the surface region of the ruthenium-type deposit comprises solid ruthenium oxide.
A ruthenium-type deposit, at least the surface region of which is solid ruthenium oxide, is brought into contact with reducing gas that contains a reducing species comprising hydrogen or hydrogen radical and the solid ruthenium oxide is thereby converted into ruthenium metal. This ruthenium metal is subsequently converted into volatile ruthenium oxide by bringing the ruthenium metal into contact with an oxidizing gas that contains an oxidizing species comprising an oxygenated compound, and this volatile ruthenium oxide is removed from the film- forming apparatus. Attachment: Replacement Sheet
